(19) United States
(12) Patent Application Publication
(10) Pub. No.: US 2009/0127344 A1
(43) Pub. Date: May 21, 2009

(54) Identification card and the production method thereof

(76) Inventors: Andreas Dostmann, Tamins (CH); Roman Burki, Davos Platz (CH); Soren Rasmussen, Maienfeld (CH)

Correspondence Address: SUGHRUE MION, PLLC, 2100 PENNSYLVANIA AVENUE, N.W., SUITE 800, WASHINGTON, DC, 20037, US

(21) Appl. No.: 11/659,119

(22) PCT Filed: Nov. 29, 2004
(86) PCT No.: PCT/CH2004/000714

§ 371 Date: Jan. 14, 2009

(30) Foreign Application Priority Data
Dec. 10, 2003 (CH) 2109/03

(51) Int. Cl. G06K 19/02

(52) U.S. Cl. 235/488

(57) ABSTRACT

Disclosed is a security document (11) having at least one paper ply (4) that is covered on both sides with a transparent plastic layer (2, 13). Disclosed is also a jacket made of transparent synthetic material, which can be used to produce said security document (11). Substantial increase in security, particularly in the production and issuance of said security document (11), can be <achieved due to the fact that the paper ply (4) is a security paper with at least one security characteristic (5, 8, 10, 15, 16) and the plastic layers (2, 13) are a sleeve made of thermoplastic material that is molten into a transparent sleeve (13) by applying only high pressure and/or temperature, wherein an edge area (14) is available at least in certain segments, in which the plastic layers (2, 13) are directly adjacent to one another and wherein at least one of the plastic layers has at least one security characteristic (3, 7).

### TECHNICAL FIELD

The present invention relates to a security document with at least one paper layer, both sides of which have been covered, in each case by a transparent plastics layer. It further relates to a pocket which is composed of transparent plastic and which can be used for production of this security document. The present invention also relates to a process for production of this security document and to a process for production of a pocket according to the invention composed of transparent plastic.

### PRIOR ART

Plastics cards for use as identification cards, members' passes, drivers' licenses, police passes and military passes, or credit cards mostly have a single- or multilayer structure and are composed, by way of example, of polycarbonate. Typically, a plastics card of this type has been provided with a print applied in the form of a thermal print or laser print (e.g. laser engraving). Multilayer plastics cards usually have a core component, both sides of which have been covered with layers composed of plastic.

In particular in the pass sector, the recent trend is increasingly toward plastics cards of the type which has been used for quite some time now in the context of credit cards. Pass documents which were previously issued on paper with the personalized data applied by writing with a typewriter or a matrix printer, etc. and with a picture applied by adhesive in the form of a photo, are increasingly being converted to plastics cards. By way of example, plastics cards in the form of pass cards are now in existence in a plurality of states for drivers' licenses, personal travel passes, or identity cards, etc. Particular security features present on these plastics cards are security prints, holograms, or hologram-like viewing-angle-dependent images, the appearance of which changes suddenly as a function of the angle of viewing (obtainable inter alia with Kinegramm™ trademark). Machine-readable codes may also be present, examples being magnetic strips (such as those conventional in credit cards), chips, transponders, or barcodes. In order to provide an additional security component for providing adequate counterfeiting security, personalization data have been applied to cards of this type in relatively complicated processes, such as laser engraving, in which a laser is used for writing on a central layer of the card. To this end, this layer has to be appropriately activated, i.e. there have to be specific admixed components activatable by way of the laser.

Although there is usually reluctance to use paper in plastics cards, particularly because paper is easily damaged by moisture, there has been previous use of multilayer plastics cards in which a supporting layer composed of plastic has been provided with at least one paper layer, in particular provided on both sides with paper layers, adhesive-bonded to the core component composed of plastic. These paper layers are relatively thin when compared with the supporting layer which is composed of plastic and gives the card its stability, and they serve for application of a print. These cards are therefore easier to print, in particular by means of an ink-jet printer. After the print has been applied, the paper layer and the applied print arranged thereon is often protectively covered by means of an outer layer, in particular by means of a cold- or hot-laminated foil, in order to protect the applied print from wear or removal, and this outer foil may also have a hologram or guilloche print, etc. applied as a security feature. Cards of this type have also previously been used as simple pass cards when there are no particularly stringent security requirements, for example as club cards or the like. Cards of this type have not previously been regarded as suitable for pass cards with high security standards, in particular pass documents issued by national governments, because of possible counterfeiting.

By way of example, GB 2129371 describes an identity card which is produced by inserting paper between two plastics foils coated with a heat-activatable adhesive, and then fusing this laminate with exposure to heat. A problem with these identity cards is the fact when heat-activatable adhesives adjoin the actual exterior layer composed of transparent plastic they opacify the entire composite, at the latest after the lamination process. This is undesirable. Furthermore, multilayer structures of this type cannot achieve the stiffness values required nowadays. In addition, intensive use brings the risk that the various layers separate from one another, and a disadvantage is that laminates of this type can also be easily separated by counterfeiters and thus can be provided with other inlays.

### SUMMARY OF THE INVENTION

The invention is therefore based on the object of providing a novel security document, in particular for use as identification card, credit card, drivers' license, police pass or military pass, or members' pass or the like, which can be produced simply and at low cost and at the same time has high security, in the context of security documents with at least one paper layer, both sides of which have been covered, in each case by a transparent plastics layer.

This object is achieved when the paper layer is a security paper with at least one first security feature, and when the plastics layers are a thermoplastic material which has been fused solely with use of elevated pressure and/or of elevated temperature to give a transparent sheath, where, at least in one or more sections, there is a marginal region in which plastics layers on both sides of the paper layer immediately adjoin one another. In addition, at least one of the plastics layers has at least one second security feature, the latter particularly preferably having been integrated into the pocket.

The core of the invention therefore consists first in the capability of using, directly for the plastics cards aspect of the safety documents sector, the security-features technology well known from the security papers sector (banknotes, checks, equity documents, etc.). These two sectors (security papers and, on the other hand, plastics cards) are traditionally different sectors which always use their own security-features technology. Simple and low-cost production of an inventive security document is provided by converting a security paper with appropriate security features to give, in some senses, a plastics card, via incorporation via fusion into a thermoplastic matrix. Firstly, this thermoplastic matrix assumes the functions of protection of the embedded paper layer(s), and secondly this matrix also provides the stiffness usually required. There is therefore no need for any further central plastics support. The marginal region of this matrix or transparent sheath moreover has a zone in which, at least in one or more sections, no paper layer is present. In other words, in this region this transparent sheath or plastics layer has been designed to assume the entire thickness of the card. Unless this marginal region is provided, a security document surrounded by plastics layers can to some degree be separated in the center by slitting the paper layer in the center parallel to the plane of the paper, with breakdown of the internal cohesion of the paper layer. Without a sealed marginal region this is readily possible in particular because the plastics layers applied act as levers and thus permit cleavage of the paper layer when a very small load is applied. This type of cleavage is readily possible in particular in the case of coated, finely milled papers with fine fibers (ink-jet papers usually being examples of papers of this type). These inventive fused marginal regions and the fusion of the substrate (security paper) to the plastic make cleavage of the paper almost impossible. The result is an enormous increase in security. The security document may be a credit card, for example, or an identification card, or a members' pass.

Another substantial feature of the method here proposed for achieving the object is that there is in principle no need for the use of adhesives or adhesion promoters to produce adhesion between the plastics layer and the paper layer, or between the plastics layers (in the marginal region). Specifically, although the paper layers and thermoplastics layers have very different chemical behavior (engineering thermoplastic on the one hand and cellulose on the other hand) they can to some extent be fused to one another, whereupon the paper layer is embedded to some extent in the plastic.

In other words, this is not actually a lamination process, but rather a process of fusion or incorporation via fusion, because, in particular if the polymers used on both sides of the security paper are identical, no layer structure can then be discerned in this matrix.

A fact which is very particularly worthy of mention in this connection is that even polymers without an actual melting point, e.g. polycarbonate, PVC, or highly amorphous polyamides, give this type of laminate structure on heating above their glass transition temperature and on application of pressure. Polycarbonate (Makrofol ID 6-2 or Makrolon PC 2250 from Bayer, DE; alternatively Lexan ML 3729 from General Electric, US) is therefore also used in one preferred embodiment, and a PVC (e.g. Pentaprint PR M278/04 from Klockner Pentaplast GmbH & Co KG, DE) or highly amorphous polyamide (e.g. Grilon or Grilamid TR90 from Ems Grivory, CH) is used in another preferred embodiment.

Specifically, the use of adhesives, whether in the form of heat-activatable adhesives or in the form of other systems as known from the prior art leads to many problems. By way of example, the use of plastics layers which have an adhesive layer on the side facing toward the paper typically produces clouding in the transparent layer after the lamination process, the clouding probably being attributable to the altered interface between adhesive layer and plastics layer (foils). This cannot occur in the present instance, because the lamination process involving the preferably identical plastics layers produces a homogeneous plastics block which cannot give rise to any such interfacial effects.

However, the omission of adhesives in particular also has technical consequences related to security. Specifically, if the plastics layers used comprise adhesion promoters or adhesives, the result is naturally layer structures in which the various layers (adhesive, plastics layer) have different physical and chemical properties. These different properties can be used to separate these layers from one another.

By way of example, if a normal heat-activatable adhesive is used, this typically has a melting point or glass transition temperature which is comparatively low, typically in the range from 90° C. to 120° C. Alongside this, however, there is a plastics layer with a melting point or glass transition temperature which is normally substantially higher, e.g. above 140° C. This difference can be utilized by counterfeiters in order to separate the layer structure, and this can be achieved without irreversible residual damage to the plastics layers. Accordingly, a system devizing embedding of a paper between two plastics layers of which at least one has an adhesive layer on the inner side can readily be separated, and there is only limited capability for prevention of counterfeiting.

In contrast to this, it is preferable in the present instance to use exclusively plastics layers whose flow point or melting point or glass transition temperature is above 120° C., preferably above 140° C., and particularly preferably in the range from 150° C. to 180° C. The lamination process or fusion process therefore accordingly forms a block which is composed of plastic and is substantially chemically and physically homogeneous and which then has no layer structure which could be utilized subsequently for separation by counterfeiters.

Another resultant advantage is that if exclusive use is made of plastics layers of this type with a high flow point the paper becomes substantially more deeply embedded into the plastics layers under the production conditions required. Penetration of the thermoplastic composition into the paper takes place during this process, whereupon an extremely stable and intimate bond is produced between paper layer and plastics layer, making subsequent separation of paper and plastic, or breakdown of the paper structure, practically impossible. Furthermore, the product is a card whose stiffness complies with current standardized requirements placed upon cards, and which cannot be achieved when using adhesion promoters.

The other problem frequently arising with use of adhesives, delamination on intensive use, can moreover be eliminated entirely, a circumstance attributable firstly to the stronger bond between plastic and paper and secondly to the fact that the plastics layer is not composed of different materials. When adhesives or adhesive layers are used, the paper becomes embedded only into the adhesive layers, which are mostly very thin, and this again reduces counterfeiting security.

These can be said to be the advantages resulting from the combination of plastics foils and a security paper. However, in the present case an additional factor is that an additional security feature is present in at least one of the plastics layers. This leads to an enormous increase in possible security in these types of security cards. Specifically, when pockets are used with plastics layers for embedding of the security paper and comprise no security feature, it can be said that the entire security responsibility is borne by the security paper. If a counterfeiter is able either to acquire or to imitate a security paper, a security card correspondingly manufactured therefrom can easily be imitated and counterfeited. This is quite unlike the present case. Here, the pocket in which the security paper is embedded is now additionally provided with at least one security feature. A consequence of this is that firstly two different products each with a high security standard can be supplied by a separate route to the end user (card issuer) (pocket with security feature and paper with security feature). A counterfeiter would therefore have to acquire or reproduce both components in order to imitate this type of security card, since each has been equipped with security features. The combination of security features of the pocket and also of the paper therefore not only leads to increased security of the final product but can also give increased security during supply of the starting materials and during production.

The security feature(s) of the plastics layers here may have been embedded in the plastics layer. In this case, a corresponding pocket is produced at the premises of a producer and by this stage has the relevant security feature. Alternatively or in addition, it is possible to provide structures in the mold with which the security card is laminated, these leading to formation of security features of the surface once the lamination process has begun. A combination of security features embedded in the pocket with security features of this type produced at the premises of the end user leads to a further significant increase in possible security, since not only the specific paper but also the specific pocket, and also the specific laminator, must be present in order to produce an identical card.

According to one first preferred embodiment of the present invention, the individual plastics layers which, as mentioned above, have been fused without the further aid of adhesion promoters, such as adhesives, to give a sheath, are composed of one and the same thermoplastic material. In other words, the pocket is preferably formed as a single block which is composed of a unitary material and which is particularly preferably present in the form of a coherent unit even prior to its fusion.

The first security feature, i.e. the at least one security feature in the paper layer, may in principle be security features from the safety papers sector. In other words, examples of those which may be used are: watermarks in the paper layer, portrait watermarks (gray-level, multitone), barcode watermarks, electrotype watermarks (filigree sharp-edged watermarks), and light and/or dark watermarks, security elements embedded at least in part or in one or more sections in the paper layer, e.g. in particular security strips (which may have been embedded by what is known as the windows process, i.e. may have some regions exposed at the surface of the paper), inkjet graphics, OCR lines, security prints (including iridescent, diffractive), OVI (optically variable inks, a mixture composed of iridescent effects and color change, i.e. inclusive of absorptive content), steel-plate (intaglio), UV print, see-through register and guilloche (in security offset), microtext, microperforation (e.g. produced by laser), barcodes, 2D barcode, colored 2D barcodes (e.g. ColorCode™), chemical security features (e.g. colored reaction in paper on solvents, bleaches, acids, and alkalis), or variously colored fibers (UV or Vis), planchettes, etc., RFIDs, chips or magnetic strips applied to the paper layer, security prints applied to the paper layer, in particular in the form of an applied fluorescent print (if appropriate with linear-polarizing properties in absorption and/or emission), or of barcodes, or of an applied intaglio print. It is very generally possible to use what are known as OVDS, i.e. optical variable devices, e.g. holograms or viewing-angle-dependent images (e.g. Kinegram™), which may have been applied in the form of foils, as patches or strips. Use may also be made of security strips with additional features, such as security writing, applied fluorescent prints or coatings, etc. Combinations of these security features mentioned can, of course, also be used. Other possible devices are taggants (e.g. in the form of up-converters; an example of a system which may be used is an anti-Stokes system using, by way of example, LUMILUX Green UC-2 from Honeywell), iridescent coatings or applied prints, and applied micro- or nanoprints.

On the other hand, in one preferred embodiment of the inventive security document, the security feature of the plastics layer involves a security feature arranged on, under, or in the plastics layer, for example integrated into the above. If security features are integrated into the plastics layers, and do not reliably withstand the pressure or the temperature during production (examples being chips, RFIDs, etc.), these can either be inserted into corresponding recesses or can be secured therein, after the production process for the plastics layers, but it is also possible to insert security features of this type into recesses of the paper prior to the lamination process. Alternatively or additionally it is possible, as mentioned above, to form the security feature from the plastics layer itself, in particular in the form of a tactile security feature arranged on the outside. This is preferably achieved by producing this type of security card in a laminator with a structured surface, i.e. one in which, during the lamination process, a three-dimensional structure is embossed in the surface using elevated pressure and/or temperature (embossing).

In principle, the security features of the plastics layer(s) can involve at least one of those selected from the following group: security strips, variously colored fibers, magnetic strips, OVD, RFID, chip, security print, planchettes, diffraction gratings, foil, hologram (or viewing-angle-dependent images); and this security feature can have been arranged in the matrix of the plastics layer or on the surface of the plastics layer or, in the case of a diffraction grating, can have been formed from the (surface) material of the plastics layers. The security feature here can preferably have fluorescent properties, and it particularly preferably exhibits linear polarized absorption and/or linear polarized emission.

Signature fields are likewise possible on the surface of the plastics layers. Fields of this type can have simple structure or can have been manufactured from materials which can be cleared by applying heat (known as thermal rewrite fields). Incidentally, magnetic strips are also provided on the outside surface of the plastics layers, for better legibility.

Incidentally, it is also possible to provide, alongside the security features in the paper and in the pocket, further separate security features which are not applied into or onto the pocket until shortly prior to the lamination process, these then being fused with the card. Thus, addition of a fourth security element can achieve a further level of security (1. paper with security element; 2. pocket with security element; 3. laminator with specific embossment structure; 4. separate security element).

In another preferred embodiment of the inventive security document, the thermoplastic material is preferably (highly) transparent thermoplastic polycarbonate (PC), or else transparent thermoplastic polyamide, polyester, polyethylene terephthalate (PET), polybutylene terephthalate (PBT), polyvinyl chloride (PVC), polymethyl methacrylate (PMMA), acrylonitrile-butadiene-styrene copolymers (ABS), polyethylene (PE), or polypropylene (PP), or a mixture or different layers thereof. The plastics layers on each side of the paper layer together with the paper layer typically have a thickness (total card thickness) which is at least 0.5 mm to preferably at least 0.7 mm. By way of example, plastics layers of about 100-200 μm or indeed 300 μm may be used on each side, and paper layers of thickness about 200-500 μm may be used.

This type of security document retains a transparent zone in the marginal region, at least in one or more sections. In order to compensate for the thickness of the paper, another preferred embodiment of the invention permits design of the document in such a way that the size of the paper layer is somewhat smaller than the plastics layers which surround it on both sides, so that, at least in one or more sections there is, a remaining transparent marginal region at the margin, and in particular the pocket has been designed in such a way that the paper layer, cut to size, has been inserted or fitted at a defined position. Because this type of transparent marginal region in one or more sections does not always meet the optical requirements based upon a plastics card, it is possible to color this marginal region specifically.

Another preferred embodiment of the present invention, which is of particular interest in connection with security strips or watermarks, and moreover can provide a specific form of security not known in the sector of conventional credit cards or identity cards manufactured exclusively from plastic is achieved by designing the paper layer such that the security document is to some extent translucent at least when viewed in front of a light source. Plastics cards such as credit cards of the prior art are namely normally non-translucent, and accordingly these plastics cards also have no security features specifically related to the transparency of the card. It is also possible to design security features in the pocket with a view to this type of transparency. By way of example, recesses in the paper layers can be provided, and specific security features can be arranged in these recesses in the pocket, i.e. in the plastics layer. Examples of these are Fresnel lenses, or other diffractive structures, for example holograms. In particular, transmission holograms can be arranged in regions of this type, these not having hitherto been used in the security cards sector.

Another preferred embodiment of the present invention is characterized in that at least one side of the paper layer has an applied print, in particular applied by means of an ink-jet printer, in particular in the form of a photo and/or personal details. This simple way of personalizing this type of security document makes its production particularly simple and inexpensive. Typically, security papers used for the paper layer are accordingly those which by this stage have a coating which makes these security papers suitable for printing by an ink-jet printer. Care should be taken here that the inks used are such that when they interact with the coating during the process of production of the card (melting of the plastics layers) they do not exhibit any adverse effects, such as running, smudging, etc. During the printing process, ink penetrates deeply into the paper or the coating, and since, as previously mentioned above, ink-jet papers will readily split (paper cleavage), the use of ink-jet technology further increases security.

Other preferred embodiments of the inventive security document are described in the dependent claims.

The present invention further provides a pocket for production of a security document described above. This type of pocket has at least one upper layer, and also at least one lower layer composed of thermoplastic material, the two layers having been bonded at least one of the edges by way of at least one bonding region, where the entire pocket has preferably been formed from a single thermoplastic material, particularly preferably from polycarbonate. The bonding region here can firstly be formed in a moveable manner so that if, for example, a bonding region has been arranged only at one edge, the pocket can be opened completely for insertion of the paper. Alternatively, the bonding region can be formed rigidly, so that the two plastics layers can be opened only to some extent and the paper can be pushed in. In this case, it is also possible to arrange the bonding region at three of the edges of the security document, particularly preferably in such a way that the bonding region extends along the entire edges.

In order to ensure that the paper layer(s) has been positioned at the correct location in the pocket, means are preferably provided in the pocket or respectively on or at the pocket which permit exact positioning of the paper layer to be inserted. These can involve depressions, grooves, or other means which permit simplified positioning of the paper layer during insertion and also keep these paper layers in the correct position during lamination.

It is further preferred that this type of pocket can have, at least one of the non-bonded edges of the layers, aids for fixing of the layers until fusion occurs. For example, after insertion of the paper layer, the sheath can be closed to some extent. These aids can in particular involve tongue-and-groove structures, grooves, ribs, click mechanisms, etc.

The dependent claims describe further preferred embodiments of the inventive pocket.

The present invention also provides a process for production of a security document as described above. A feature of this process is that after the at least one paper layer (this usually being a security paper) has been personalized, in particular with the aid of an ink-jet printer, it is inserted into a pocket, particularly preferably into the pocket described above, and this layer structure is fused with use of pressure and/or of elevated temperature to give a transparent sheath in essence enclosing the paper layer on all sides, without further assistance of adhesion promoters, such as adhesives. This process produces, in the marginal region, zones in which the plastics layers have been fused to one another over the entire thickness of the card. The pocket has preferably been produced from polycarbonate or PVC, or from preferably highly amorphous polyamides.

In a process which has proven advantageous, a combination of elevated temperature in the range below the glass transition temperature of the plastic used and pressure of more than 10⁶ Pa (e.g. in the region of 1.5×10⁶ Pa) is used for the fusion process, and a specific profile is particularly preferably traversed here in relation to pressure and temperature. By way of example, in the case of polycarbonate, the temperature in a laminator is first increased to the region of about 150 to 160 degrees Celsius, the pressure is then increased to the region of 1.4×10⁶ Pa, and then the temperature is lowered to about 110 to 120 degrees Celsius, and then the pressure is again increased somewhat to the region of 1.5×10⁶ Pa or indeed 1.57×10⁶ Pa.

According to one first preferred embodiment of the process, the fusion takes place in a mold which embosses the surface of the security document with at least one security feature during its fusion (embossing). This security feature preferably involves a tactile security feature (checkable via touch) and/or an optical grid, a particularly preferred example being a Fresnel lens.

As previously mentioned at an earlier stage above, it is also possible to obtain a further increase in security by, prior to the fusion process, inserting at least one further security feature alongside the paper layer between paper layer and plastics layers, or into recesses in the paper layer, or to position this feature between plastics layers and laminating mold. To this end, it is preferable that means, in particular in the form of depressions or the like are provided in the plastics layers, these means permitting precise positioning of these additional security features and minimizes risk of their disarrangement.

The dependent claims describe further preferred embodiments of the process for production of a security document.

The present invention further provides a process for production of the pocket described above, i.e. for production of this type of security document. The process is characterized in that, in a molding process, in particular in an RIM process (rapid injection molding), the pocket is formed, starting from pellets, for example composed of polycarbonates or PVC, and at least one security feature has been provided in the mold here in such a way that this then has been fixed in and/or on and/or in the pocket. In this type of production process it is preferable that the pocket composed of polycarbonate pellets or of PVC pellets is produced at a temperature in the range from 300 to 400° C. and at a pressure in the range from 200 to 300 bar within a period of from 5 to 10 seconds. Possible pellets are obtainable by way of example with the trademark Makrolon (Bayer, DE) or Lexan (General Electric, US).

The present invention further provides a use of an inventive security document as a card for identification and/or authentication of the carrier with, if appropriate, subsequent issue of right to access or right to acquisition, and in particular as an identity card, a credit card, an identification card, an access card, or a members' pass.

### BRIEF EXPLANATION OF THE FIGURES

The invention will be further illustrated below using inventive examples in connection with the drawings.

FIG. 1 shows sections through inventive security documents immediately prior to or after fusion to give a security document, where a) shows a section through a security document with inserted paper layers prior to its fusion with embedded security element, both in the paper layers and in one of the plastics layers, b) shows a section as in FIG. 1a), but here there is additionally an adjustment aid or a border edge provided at the side which has the opening and which faces away from the region of bonding of the two outer layers; c) shows a section as in FIG. 1b), but additionally here a tactile security element has been provided at the surface, as also have means for fixing of the pocket at the side which has the opening, and d) shows a section through a finished, i.e. fused, security document;

FIG. 2 shows a plan view of an opened pocket or inserted security paper, and the method of bonding of the two plastics layers by way of bonding regions is discernable here; and

FIG. 3 shows plan views of inventive security documents, where a) shows a card with peripheral margin and b) shows a card with toothed margin.

### METHODS OF WORKING THE INVENTION

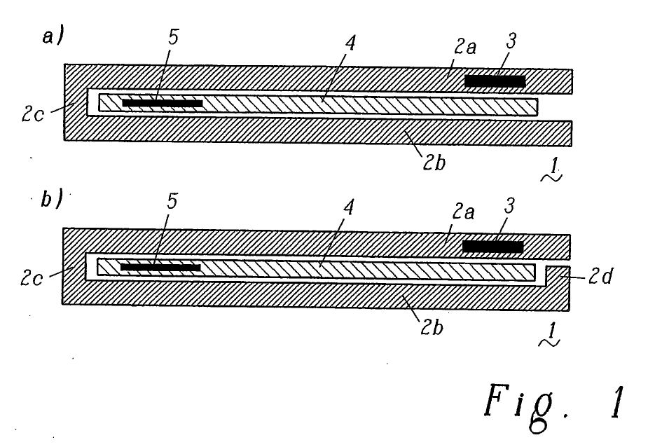

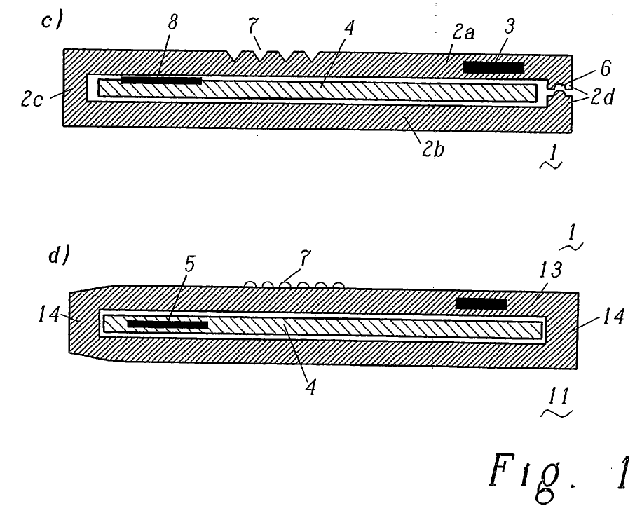

FIG. 1 shows various inventive examples, where each of FIGS. 1 a) to c) shows sections through unfinished identification cards which have not yet been fused.

FIG. 1a) shows the simplest inventive example. A paper layer 4 is placed between two transparent layers 2a and 2b of a pocket. The two plastics layers 2a and 2b have been bonded at one edge by way of a bonding region 2c to form the pocket 2. The bonding region 2c here can be present at only one edge, so that it is possible to open the pocket 2 rather like a book, but another possibility is that the two layers 2a and 2b have been connected at two or three edges by way of bonding regions bonded to one another, so that the paper layer 4, which has a security element 5, can, by way of example, only be pushed in from one side.

The pocket 2 has been produced from a single material. The pocket 2 moreover has a security feature 3, which has been integrated into one of the layers 2a/2b or into a marginal region 2c/2d. The material of the pocket 2 preferably involves polycarbonate. Other thermoplastics are conceivable and possible, however, examples being polyethylene, polypropylene, ABS or the like. In principle, the material of the pocket has to involve a thermoplastic which permits fusion of the layers at temperatures or pressures at which there is no damage to the paper layer 4 or to security elements present in or on the paper layer or to applied prints during the lamination process or fusion process. Equally, the lamination process or fusion process is not permitted to damage security elements provided in the pocket or on the pocket 2. In other words, the glass transition temperature of the material used should typically be below about 150 to 180 or 200° C., i.e. polycarbonate lies just within the range of materials that can be used.

Furthermore, at least one of the two plastics layers 2a or 2b should, of course, be transparent, in order that the information applied on the paper layer 4 or the security elements arranged in or on the paper layer 4 remain visible after the fusion process. In other words, the pocket does not necessarily have to be transparent prior to the fusion process, but rather has to be transparent after the fusion process to give a sheath surrounding the paper layer.

The plastic used for the pocket was, for the purposes of the present inventive examples, material from Bayer, DE, available in the form of pellets as Makrolon PC 2250. This was molded in an RIM process to give a pocket. The security feature 3 was also integrated into the pocket 2 in an in-mold labeling process. The thicknesses of the layers 2a and 2b are typically about 300 μm. Specifically, if the intention is to use this type of card as an identity card, the card has to comply with international standard, and specifically the ISO/IEC 7810 standard, which specifies, inter alia, that the thickness of this type of identification card has to be 0.76 millimeters, the tolerance being in the range +/−0.08 mm. Another feature of polycarbonate making it suitable in relation to this standard is that it permits compliance with the required stiffness (cf. section 8.1.1 of ISO/IEC 7810).

The paper layer 4 is a security paper with at least one security feature, preferably with a combination of a plurality of security features. The paper layer 4 should be printable by an ink-jet printer, i.e. it should have coatings which make the substrate capable of absorbing and fixing inks of this type. The particular paper used in the present instance had a coating known as Digisafe from Landqart, CH. The weight of the paper per unit of surface area was 90 g/m². Very generally, it is found that for high security the paper should, as far as possible, be sufficiently thin that the ink penetrates through a substantial portion of the paper thickness, thus making paper cleavage more difficult. However, on the other hand, the paper must, of course, still be sufficiently thick to be capable of providing the required opacity and the required printing properties.

In the example of FIG. 1a) or 1b), the paper layer 4 has a security feature which is a security element 5 embedded into the paper layer. An example of this can be a security strip (e.g. a plastics strip with a vapor-deposited metallic layer, and fluorescent colors may also have been incorporated here, if appropriate) which is either inserted into the paper pulp in such a way that it does not reach the surface of the paper layer 4 at any point, or else as what is known as a “window” strip, which appears at one or more surfaces, in one or more sections. Security strips of this type and their embedding into the paper are well known from the banknotes sector. Variously colored fibers may also be used. The paper layer 4 may also have a security feature which is a security element 8 applied by printing or applied by adhesion. An example of this security element is an applied security print, as known from the field of banknotes. Correspondingly, use may be made of an intaglio print, prints with fluorescent or phosphorescent security inks or, respectively, pigments, or of microprints, barcodes, or the like. Examples of security features which may be used as an alternative or additionally are taggants, iridescent prints, planchettes, microprints, etc.

Other possible security elements 8 as shown in FIG. 1C) are elements applied by adhesion or otherwise to the paper layer 4, e.g. kinegrams, holograms, chips, magnetic strips (which can, however, also be subsequently applied externally), RFIDs (radio frequency induced devices). Care sometimes has to be taken here that these security elements are not damaged during the fusion or lamination process, i.e. the plastics used have to comprise those whose glass transition temperatures are appropriately low and which can be fused at appropriately relatively low pressure, but whose glass transition temperatures nevertheless are higher (typically >120° C.) than that of any commonly used hotmelt adhesive, because otherwise no true fusion of the matrix can take place.

In addition to these security elements applied to the paper layer 4, the invention permits introduction of additional security elements of the paper layer which are needed for checking purposes or for satisfactory functioning of a transparent substrate. Examples of these security elements are foils with polarized absorption and/or emission, dichroitic mirrors, color filters, UV-absorbent filters, special-effect grids, etc. and these may also be introduced in a recess of the paper layer.

A watermark 10 in the paper layer may also be used as security element. This is a particularly preferred security element in connection with the present invention, because it is not yet used in connection with conventional plastics cards, is very difficult to imitate, and represents what is known as a “human feature”, i.e. a security feature which can be verified directly by the naked eye, e.g. by holding the material up to the light, without the aid of specialized apparatus. The watermark 10 is particularly preferably the type known as a gray-level watermark, which can only be produced under specific conditions and using specific papermaking machines, and which is known from the security papers (in particular banknotes) sector.

As mentioned above, according to the invention, the pocket also has at least one security feature. This can, for example, have been embedded. Here again this can, for example, involve a security strip (e.g. a plastics strip with a metallized layer, if appropriate also with incorporation of fluorescent inks), the manner of insertion of this strip into the plastics composition being such that it does not at any point reach the surface of the plastics layers. Use can also be made of variously colored fibers. The pocket 2 can also have a security feature in the form of a security element 8 applied by printing or applied using an adhesive. This security element can, for example, be an applied security print. Accordingly, use can be made of intaglio print, prints with fluorescent or phosphorescent security inks and, respectively, pigments, or of microprints, or of barcodes or the like. Examples of security features that can be used alternatively or additionally are taggants, iridescent prints, planchettes, microprints, etc.

Examples of security elements equally possible for the pocket 2 are elements applied to the pocket 2 using adhesive, or integrated into this pocket or otherwise applied, examples being viewing-angle-dependent images (e.g. Kinegram™), holograms, chips, magnetic strips (although these can also be subsequently applied to the outside), RFIDs (radio-frequency-induced devices). Care has sometimes to be taken here that these security elements are not damaged during the fusion process or lamination process, or else in particular during the production of this type of pocket in an RIM process, in which the prevailing conditions are typically even more extreme, i.e. the plastics used have to be those whose glass transition temperatures are appropriately low or which can be fused at appropriately relatively low pressure, but whose glass transition temperatures nevertheless are higher (typically >120° C.) than those of familiar hot-melt adhesives, since otherwise no genuine fusion of the matrix can take place.

In addition to these, or alternatively, it is also possible to provide three-dimensional security features 7, as given in FIG. 1c) and in FIG. 1d). These can be present even prior to fusion, although then it is necessary to ensure that they are not completely removed during the fusion process. It is preferable that production of security features 7 of this type, in a surface embossing process, is delayed until the material has reached the mold used for the fusion process.

FIG. 1b shows an embodiment of an inventive example as in FIG. 1a). For simplified positioning of the paper layer (or, if appropriate, of the plurality of paper layers), an adjustment aid 2d has been provided. This can take the form of a rib which prevents the paper layer 4 from shifting in the pocket 2. Ribs of this type have typically been provided at those edges at which there are no bonding regions 2c provided.

FIG. 1c) shows a further inventive example, in which firstly a further security feature 7 has been provided in the form of an optical grid or of a tactile security feature on the surface of the pocket 2. Furthermore, means 6 have been provided, specifically tongue and groove, permitting temporary fixing of the pocket after the paper layer 4 has been pushed in.

The layer structures of FIGS. 1a) to c) are fused in a lamination process to give the actual identification card 11 shown in FIG. 1d). The example given here relates to a card of the thickness 0.76+/−0.08 mm, as required by the ISO standard. For this, the layer structures are exposed to an elevated pressure and an elevated temperature, in a laminator which preferably has a mold which can emboss a structure indicated by reference numeral 7, the temperature and the pressure preferably being adjusted so as to reach the region of the glass transition of the plastics foils used. It is preferable to traverse specific profiles, and by way of example in the present instance, using polycarbonate, the temperature was first raised to 157.7 degrees Celsius and then kept steady for about 50 seconds, and then the material was cooled by a fan for about 50 seconds, and then an elevated pressure of about 1.42×10⁶ Pa was applied, and then the material was cooled to about 120 degrees Celsius at constant pressure, and then the pressure was again further increased to about 1.5×10⁶ Pa or indeed 1.57×10⁶ Pa. Finally, the material was cooled to 30 degrees Celsius and the laminator was reopened. The cards may subsequently be die cut in order to obtain a clearly defined circumferential edge.

For technical imaging reasons, FIG. 1d) shows a gap between paper layer 4 and the fused sheath 13, but the lamination process actually gives an intimate bond between the paper layer and the plastics foils. During the laminating process, plastic penetrates the paper fibers or the coatings of the paper layer 4 and to some extent anchors the sheath 13 to the paper layer 4. Accordingly, after lamination it is impossible to separate a plastics layer from the paper layer without paring away at least portions of the uppermost layer of the paper layer with the plastics layer. The result is inherently higher security of this type of identification card. Another possible security feature using current technology consists in specific stamped features in the paper layer (if appropriate consequences of holes forming a text or forming numerals), into which the plastics layers then penetrate during the fusion process. In particular, a combination using security features arranged with precise registration thereto in the plastics layer 2a and/or 2b can give rise to entirely new designs using windows with specific properties.

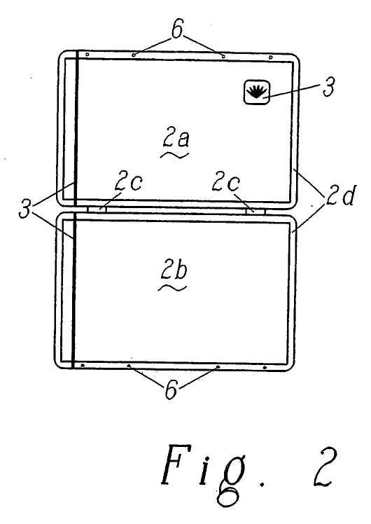

FIG. 2 shows a pocket 2 composed of two layers 2a and 2b, these having been bonded at only one edge by way of two bonding elements 2c. Each of the layers 2a and 2b has, in the marginal region, a raised area 2d which correspondingly leads to a depression into which the paper layer can be inserted with precise fit. Furthermore, the possibility is provided of closing the pocket 2 by way of a click mechanism of the means 6, in order to fix the pocket after insertion of the paper layer and prior to the fusion process. The right-hand upper side of the pocket here has a security feature 3, which has been integrated in one of the two layers 2a. It moreover has by way of example a security strip, which is present in the two layers 2a and 2b.

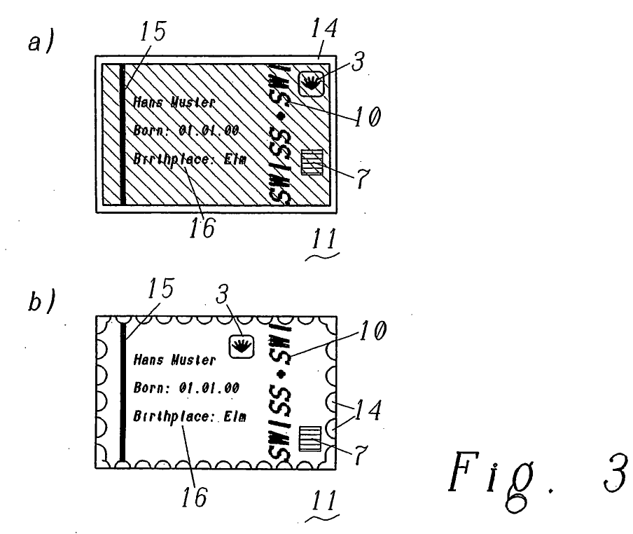

FIG. 3 shows plan views of inventive examples. FIG. 3a) shows an identification card which has a peripheral transparent margin 14. In the region of this peripheral margin 14, the sheath 13 has been completely fused, and accordingly it is also almost impossible, unlike in conventional adhesive-bonded or glued cards, to separate the upper and the lower plastics layer from one another and thus possibly to make duplicates of this type of identification card. The identification card 11 has a security strip 15 inserted into the paper, and also has a watermark 10 which, like the security strip 15, is discernible in particular on viewing through the material. The identification card also has an applied print 16 with which the card has been personalized. This applied print 16 is generated, by way of example, by an ink-jet printer prior to lamination. In addition, or on the other side, a color photo may also be applied by printing, as, of course, also may other information appropriate to correct use. The security card also has a security feature 3 integrated in the pocket. A further tactile security feature 7 has likewise been provided; production of the latter was delayed until the pocket was fused in the laminator.

FIG. 3b) shows an inventive example in which the transparent margin 14 is not fully peripheral. Here, the paper layer has a toothed margin, analogous to a postage stamp. Accordingly, there are sections with transparent marginal regions 14. These marginal regions 14 can, of course, be colored, so that the card is then seen to have no transparent region at all.

In principle, the following advantages result from the proposed procedure when comparison is made with the prior art:

For the sheath, the prior art fuses polycarbonate to the activated layer. In contrast to this, in the present instance the paper is fused in the form of an inlay in a polycarbonate pocket. In the case of the card proposed with the security paper core, which in itself is intrinsically a highly secure document, as used in passes, for example, all of this is additional to the capabilities of the card made purely of plastic and security features have been additionally provided in the pocket here, thus increasing the overall level of security. Tests have shown that it is very difficult to separate the paper/plastic combination, firstly because the plastic is fused to give a unitary body and no longer has an obvious layer structure, and secondly because the ink penetrates deeply into the paper during the printing process and moreover diffuses into the plastic during the fusion process. It is also difficult to manipulate one layer, because the original image always remains, and is therefore visible, on the other layer. This considerably increases the cost for the counterfeiter. A laser-sensitive layer can also be incorporated concomitantly in the newly developed card, thus permitting subsequent inscription by this technology, if this is desired.

### KEY

1 Identification card, not yet bonded
2 Transparent pocket
2a Upper layer of 2
2b Lower layer of 2
2c Bonding region of 2a and 2b
2d Adjustment aid or border edge at opening side of 2
3 Security feature embedded in 2 or arranged on 2
4 Security paper
5 Security element embedded into 4
6 Aid for bonding layers 2a and 2b, i.e. edges 2d
7 Tactile security feature on 2
8 Security feature applied to 4 by printing or by adhesive bonding
10 Watermark (shown diagrammatically)
11 Finished identification card
12 Oblique marginal region
13 Transparent sheath, fused
14 Transparent marginal region
15 Security strip
16 Applied print
17 Toothed margin

1. A security document with at least one paper layer, both sides of which have been covered, in each case by a transparent plastics layer, wherein:
the paper layer is a security paper with at least one first security feature, and the plastics layers are a pocket composed of thermoplastic material which has been fused solely with use of elevated pressure and/or of elevated temperature to give a transparent sheath, where, at least in one or more sections, there is a marginal region in which plastics layers immediately adjoin one another, and where moreover at least one of the plastics layers has at least one second security feature.

2. The security document as claimed in claim 1, wherein the plastics layers have been fused without further assistance of adhesion promoters such as adhesives to give a sheath, and in that the security feature has been integrated in the pocket.

3. The security document as claimed in claim 1, wherein the plastics layers are composed of one and the same thermoplastic material.

4. The security document as claimed in claim 1, wherein the plastics layers encompass exclusively thermoplastic material with a glass transition temperature above 100° C., preferably above 120° C., particularly preferably in the range from 140 to 200° C.

5. The security document as claimed in claim 1, characterized in that it wherein the document is a card for identification and/or authentication of the carrier with, if appropriate, subsequent issue of right to access or right to acquisition, and in particular is a credit card, an identification card, an access card, or a members' pass.

6. The security document as claimed in claim 1, wherein the first security feature in the paper layer is a watermark in the paper layer, in particular watermark of one of the following types or combinations thereof: portrait, gray-level, multitone, barcode, electrotype, or is a security element embedded at least in part or in one or more sections within the paper layer, e.g. in particular a security strip, optionally exposed at least in one or more sections at the surface of the paper, or variously colored fibers, or is a OVD, RFID, OCR, OVI or chip, or magnetic strip applied to the paper layer, or is a security print applied to the paper layer, in particular in the form of an applied fluorescent print or of an applied steel intaglio print UV pressure, guilloche, barcode, microperforations, transparent register, chemical securities, or is a combination of these security features.

7. The security document as claimed in claim 1, wherein the security feature of the plastics layer is a security feature arranged on, under, or in the plastics layer.

8. The security document as claimed in claim 7, wherein the security feature has been formed from the plastics layer, in particular in the form of a tactile security feature arranged on the outside.

9. The security document as claimed in claim 7, wherein the security feature of the plastics layer is at least one of the security features selected from the following group: security strip, variously colored fibers, magnetic strip, OVD, RFID, chip, security print, planchettes, diffraction grating, foil, hologram; where this security feature has been arranged on the inside and/or on the outside, in the matrix of the plastics layer or at the surface of the plastics layer, or, in the case of a diffraction grating, can have been formed from the surface material of the plastics layers, and where the security feature preferably has fluorescent properties, particularly preferably here having linear polarized absorption and/or linear polarized emission.

10. The security document as claimed claim 1, wherein the thermoplastic material is preferably transparent thermoplastic polycarbonate (PC), or else transparent thermoplastic polyamides, polyphthalamides, polyester, polyethylene terephthalate (PET), polybutylene terephthalate (PBT), polyvinyl chloride (PVC), polymethyl methacrylate (PMMA), acrylonitrile-butadiene-styrene copolymers (ABS), polyethylene (PE) or polypropylene (PP), or a mixture or combination thereof.

11. The security document as claimed claim 1, wherein the plastics layer on each side of the paper layer, and the paper layer together have a thickness which is at least 0.5 mm to preferably at least 0.7 mm.

12. The security document as claimed in claim 1, wherein the size of the paper layer is somewhat smaller than that of the plastics layers which surround it on both sides, so that, at least in one or more sections, there is a remaining transparent colorless or a remaining colored opaque, or a remaining colorless opaque marginal region at the margin.

13. The security document as claimed claim 1, wherein the design of the paper layer is such that the security document is to some extent translucent at least when viewed in front of a light source.

14. The security document as claimed in claim 1, wherein at least one side of the paper layer has an applied print, in particular applied by means of an ink-jet printer, in particular in the form of a photo and/or personal details.

15. A pocket for production of a security document as claimed in claim 1, characterized in that the pocket has at least one upper layer, and also at least one lower layer, composed of thermoplastic material, where the two layers have been bonded at least one of the edges by way of at least one bonding region, and where the entire pocket has preferably been formed from a single thermoplastic material, particularly preferably from polycarbonate or PVC, and where the pocket has at least one security feature.

16. The pocket as claimed in claim 15, wherein means have been provided which permit exact positioning of the paper layer to be inserted.

17. The pocket as claimed in claim 16, wherein the means take the form of depressions and/or raised areas, into which the paper layers can be inserted with precise fit prior to the fusion process.

18. The pocket as claimed in claim 15, wherein, at least one of the unbonded edges of the layers, aids have been provided for fixing of the layers prior to fusion.

19. The pocket as claimed in claim 15, wherein the two layers have been bonded at two edges, particularly preferably at three edges by way of bonding regions.

20. A process for production of a security document as claimed in claim 1, wherein, after the at least one paper layer has been personalized, in particular with the aid of an ink-jet printer, it is inserted in a pocket, particularly preferably in a pocket as claimed in claim 15, and this layer structure is fused with use of pressure and/or of elevated temperature to give a transparent sheath in essence enclosing the paper layer on all sides, without further assistance of adhesion promoters, such as adhesives.

21. The process as claimed in claim 20, wherein the fusion process takes place in a mold which embosses at least one security feature on the surface of the security document during its fusion, this security feature preferably being a tactile security feature and/or a grating, such as particularly preferably a Fresnel lens.

22. The process as claimed in claim 20, wherein a combination of elevated temperature in the range below the glass transition temperature of the plastic used and pressure of more than 10⁶ Pa to 1.6×10⁶ Pa is used for the fusion process, and a specific profile is particularly preferably traversed here in relation to pressure and temperature, and where the fusion time used is particularly preferably less than 30 seconds.

23. The process as claimed in claim 20, wherein, after the fusion process to give the sheath, the security document is stamped to give its final form.

24. The process as claimed in claim 20, wherein, prior to the fusion process, alongside the paper layers at least one further security feature is inserted between paper layer and plastic layers, a particular preference here being that, in the plastics layers, means have been provided in particular in the form of depressions, permitting positioning of these additional security features.

25. The process for production of a pocket as claimed in claim 15, wherein, in a molding process, in particular in an RIM process, the pocket is formed from pellets, at least one security feature has been provided in the mold here in such a way that this then has been fixed in and/or on the pocket.

26. The process as claimed in claim 25, wherein the pocket is produced from polycarbonate pellets and/or from PVC pellets at a temperature in the range from 300 to 400° C. and at a pressure in the range from 200 to 300 bar within a period of from 5 to 10 seconds.

27. The use of a security document as claimed in claim 1 as a card for identification and/or authentication of the carrier with, if appropriate, subsequent issue of right to access or right to acquisition, and in particular as an identity card, a credit card, an identification card, an access card, or a members' pass.
